(19) United States
(12) Patent Application Publication
(10) Pub. No.: US 2009/0156718 A1
(43) Pub. Date: Jun. 18, 2009

(54) Caulking Bead Agent and Method of Creating an Improved Caulking Bead

(76) Inventors: John R. Hinton, Alvin, WI (US); Stuart Buck, Battle Creek, MI (US)

Correspondence Address: Chad A Coberly, 9318 Ricker St, Richland, MI, 49083, US

(21) Appl. No.: 12/275,199

(22) Filed: Nov. 20, 2008

Related U.S. Application Data
(60) Provisional application No. 60/989,173, filed on Nov. 20, 2007.

(51) Int. Cl. C08L 9/02; C08K 5/20; C08K 5/06; C08K 5/55; C08K 5/3415; C08K 5/52; C08K 5/5333

(52) U.S. Cl. 524/130; 524/223; 524/394; 524/565; 524/566; 524/185; 524/104; 524/140

(57) ABSTRACT

A composition for creating a perfect bead of caulk by spraying the substance on a caulk line of any type of caulk and smoothing the line with an implement. The compound provides for the release of caulking agents thereby reducing the coefficient of friction at the surface of the caulk in order to allow the use of a finger or tool to create a symmetric and aesthetically pleasing bead of caulk. The invention is non-hazardous, does not stain or leave a residue on the caulk line or surrounding surfaces, can be painted, can be used with any type of caulk. The release agent comprises a co-solvent, a carrier, a surfactant, a polymer, a defoamer, a coupling agent, and a corrosion inhibitor to optimize the composition for the ideal spraying application.

### FIELD OF THE INVENTION

The present invention relates a substance intended to assist in creating a symmetric and aesthetically pleasing bead of caulk. More specifically, the invention relates to the concept of enabling a user to spray a chemical compound on any caulk (Acrylic, Silicone, Polyurethane and Latex) and achieve a perfect bead of caulk, easily wipe off all excess material and do all of this in a fraction of the time required for the conventional application apparatus and methods. The invention is applicable to the construction trades and particularly suited for the non-professional user of caulking products.

### BACKGROUND OF INVENTION

Historically, creating a bead of caulk along a joint such as a tile, wall, or fixture has been difficult to achieve a symmetric, clean bead. Traditionally, one creates a bead of caulk by squeezing a caulking agent out of a tube with either a caulking gun or by squeezing the container of caulk through a nozzle into or around a seam or joint. Often the caulk becomes uneven as it comes out of the nozzle which presents as an uneven bead that is un pleasing to the eye. The desired bead is even on both edges and contains no more caulk than is necessary to seal the desired joint. Often, after application of the caulk, a tool such as a finger or applicator is used to smooth the caulk bead to the desired geometry. Often the application of the tool is troublesome due to the adhesive nature of the caulk. The tool becomes clogged and often creates a more un-pleasing bead and mess of the caulk line. The problem then is to create a substance or tool to help the user create the perfect bead of caulk.

There has been much work on tools and implements and substances to assist in the caulk bead application. U.S. Pat. No. 4,981,629 issued to Cook, describes a method of applying caulk wherein a specific geometric caulk application tool is used to apply the caulk and subsequently smooth the caulk bead in order to create the desired shape of the bead. This patent is in a series of numerous similar inventions directed to bead smoothing apparatus. There have been numerous different shapes and compositions of tools developed to assist in the bead application. These tools are all used either immediately after the application of the caulk or some have even been integrated into the caulking nozzle in an attempt to smooth the joint as soon as possible after the caulk application. The issue with most of these tools is that they have a propensity to become clogged due to the adhesive nature of the caulk and therefore end up creating an uneven bead due to the binding of caulking material to the implement.

Another way to solve the caulking bead problem is similar to that of the invention described herein. Namely a caulking release agent that is applied to the caulking bead after the application of the caulk that assists in smoothing and removing some of the surface adhesion characteristics of the caulk to allow an implement such as a finger or tool to be applied to the caulk without binding with the excess caulk. One such invention is described in U.S. Pat. No. 6,656,886 issued to Johnson, Lubricant for Smoothing Caulking Joints and Method of Use. This reference discloses a lubricant and method of use for smoothing and shaping a bead of caulking. The reference discloses a chemical substance comprising a phosphate free, neutral PH compound with at least one surfactant, at least one stabilizing compound, a water, and a biocide. While the composition has many of the desired properties for such a substance, the substance is designed to be applied by adding drops of the substance directly onto the smoothing implement prior to application that may prove to be difficult to apply to a long bead line. Furthermore, the biocide in the substance that allegedly acts as an anti-bacterial agent is un-necessary and may complicate the compound.

The desired release agent can be sprayed on the caulk line so that it can cover a large line of caulk. Does not immediately evaporate, is non-hazardous to the skin, does not stain or leave a residue on the caulk line or surrounding surfaces, can be painted, can be used with any type of caulk including difficult epoxies, and allows the user to easily apply the substance and use a finger to create the perfect bead of caulk.

### ADVANTAGES OF INVENTION

The present invention has several advantages over the art described. Including but not limited to, the caulking release agent is formulated such that it can be sprayed onto the caulk line, is non-hazardous, does not stain or leave a residue on the caulk line or surrounding surfaces, can be painted, can be used with any type of caulk including difficult epoxies, and allows the user to easily apply the substance and use a finger to create the perfect bead of caulk. The invention can be captured in an aerosol and sprayed. The substance can be easily manufactured, contains only the ingredients necessary to allow it to perform, is stable and can be stored and dispensed in generally accepted containers.

### SUMMARY OF INVENTION

The invention is a novel composition for creating a perfect bead of caulk by spraying the substance on a caulk line of any type of caulk and smoothing the line with a finger. The invention provides for the release of caulking agents thereby reducing the coefficient of friction at the surface of the caulk in order to allow the use of a finger or tool to create a symmetric and aesthetically pleasing bead of caulk. The invention is non-hazardous, does not stain or leave a residue on the caulk line or surrounding surfaces, can be painted, can be used with any type of caulk. The release agent comprises a solvent, a carrier, a surfactant, a polymer, a defoamer, and a rust inhibitor to optimize the composition for the ideal aerosol spraying application.

### BRIEF DESCRIPTION OF THE DRAWINGS

There are no drawings contained in this application.

### DESCRIPTION OF PRACTICAL EMBODIMENTS

The invention comprises a combination of chemical ingredients in amounts determined through experimentation to create the ideal release agent to be utilized via spraying on all types of caulk. Specifically, an embodiment of the invention comprises a surfactant, a coupling agent, at least one polymer, a carrier a defoamer, a corrosion inhibitor, a co-solvent, and an aerosol propellant. A preferred embodiment comprises Coalamide C as the surfactant, Glycol Ether DE as the co-solvent, Rhoplex 1531 as the acrylic polymer, water as the carrier, and Foam ban MS 550 as the defoamer. The weights of the ingredients in the preferred embodiment comprise 3.5% surfactant, 12.3% co-solvent, 7% acrylic polymer, 76.45% deionized water, 0.5% defoamer, and 0.25% rust inhibitor. The weights of the chemicals described may be altered within ranges of plus or minus 25% of each compound resulting in similar desired properties. The resulting compound is then combined with an aerosol propellant and a lubricant, preferably R134A aerosol, and placed in a can for dispensing purposes. Alternatively, the propellant may consist of one or a combination of the following propellants: nitrous oxide, 1,1 difluoroethane (152A), dimethyl ether, 1,1,1,1 tetrafluoroethane (134A), liquefied petroleum gases (propane, isobutane, n-butane), isopentane, n-pentane. The propellant comprises a minimum of two percent, 2%, and a maximum of forty-five percent, 45%, by weight of the volume of the invention. The preferred aerosol format allows for the fastest application of the agent.

Furthermore, other embodiments are contemplated by those skilled in the art that alternate one or more of the chemicals described in the preferred embodiment that may result in a similarly acting substance. The invention is not limited to the specific chemicals described, but rather to the generic family of chemicals referenced. In particular, the polymer may contain acrylic functionality and comprise one or any combination of styrene-butadiene rubber, poly-vinyl acetate, acrylic, ethylene-vinyl acetate, poly vinyl chloride, acrylonitrile-butadiene-styrene, styrene-butadiene rubber, butyl rubber, silicone, urethane, or polyurethane. The Polymer acts to add adhesive properties to the invention and may comprise up to twenty-six percent 26%, by weight the volume of the invention. The defoamer is a critical substance for the smooth spraying of the compound and the defoamer described in the preferred embodiment, Foam Ban MS 550, was selected solely based on availability and there are other equivalent defoamers that will work equally as well in combination with the described composition. The surfactant comprises a minimum of one percent, 1%, and a maximum of fifteen percent, 15%, by weight the volume of the invention. The surfactant may comprise any of the following group: alky polysaccharides, alkylamine ethoxylates, amine oxides, block copolymers, caster oil ethoxylates, ceto-oleyl alcohol ethoxylates, ceto-stearyl alcohol ethoxylates, decyl alcohol ethoxylates, dinonyl phenol ethoxylates, dodecyl phenol ethoxylates, end-capped ethoxylates, alkyl dimethylamines, alkyl amidopropylamines, quaternised amine ethoxylates, quaternary ammonium compounds, diethanolamines, comb-graft copolymer, condensed naphthalene sulphonates, polycarboxylates, ethoxylated alkanolamides, ethylene glycol esters, fatty acid alkanolamides, fatty alcohol alkoxylates, lauryl alcohol ethoxylates, mono-branched alcohol ethoxylates, nonyl phenol ethoxylates, octyl phenol ethoxylates, random copolymer alkoxylates, sorbitan ester ethoxylates, stearic acid ethoxylates, synthetic alcohol ethoxylates, tall oil fatty acid ethoxylates, tallow amine ethoxylates, alkyl ether phosphates, alkyl phenol ether phosphates, alkyl phenol ether sulphates, alkyl naphthalene sulphonates, condensed naphthalene sulphonates, fatty alcohol sulphates, alkyl ether carboxylic acids and salts, alkyl ether sulphates, mono-alkyl sulphosuccinamates, di-alkyl sulphosuccinates, alkyl phosphates, alkyl benzene sulphonic acids and salts, alpha olefin sulphonates, alkyl ampho(di)acetates, amido betaines, alkyl betaines, fluorosurfactants, aromatic hydrocarbon sulphonic acids, salts and blends.

The co-solvent comprises from the group of chemicals including but not limited to: alcohols, ketones, glycols, esters, aliphatics, aromatics, amines, glycol ethers.

The coupling agent comprises a minimum of one percent, 1%, and a maximum of twenty-five percent, 25%, by weight of the volume of the invention. The coupling agent comprises from a group of chemicals consisting of glycols, glycol ethers or glycol ether esters.

The corrosion inhibitor comprises a minimum of 0.1%, and a maximum of 0.75%, by weight of the volume of the invention. The corrosion inhibitor comprises from a family of: alkanolamine borate, ammonium benzoate, azoles, amines, nitrites, phosphates, molybdates, phosphonates, silicates or chromates.

The defoaming agent comprises a minimum of 0.1%, and a maximum of 5%, by weight of the volume of the invention. The defoaming agent comprises from the group siloxanes, polyglycols, emulsified fatty acid/fatty alcohols or acetylenic compounds.

The water comprises a minimum of five percent, 5%, and a maximum of ninety percent, 90%, by weight of the volume of the invention. The type of water is not critical but may come from the following sources, or any combination, provided it is free of particulate matter as to not interfere with the ability of the product to be delivered through an aerosol orifice: public, bottled, spring, distilled or de-ionized.

The invention may also include: rheology modifiers, fragrances, biocides, bitterants or other additives that do not impede the performance of the invention and may enhance tertiary attributes of the product.

The invention combines to create a substance that satisfies the desired characteristics of such a substance. Namely, the invention is non-hazardous, does not stain or leave a residue on the caulk line or surrounding surfaces, can be painted, can be used with any type of caulk including but not limited to: acrylic latex, sbr latex, silicone and polyurethane.

The method of using the invention includes spraying the substance from the container a few inches above the applied bead of caulk, and wiping the caulk with a finger thereby creating a symmetric, geometrically pleasing bead line.

A primary benefit of the invention is that it does not need to be removed from the cured caulk or sealant and will not interfere with any of the finished product attributes including but not limited to: ability to be painted, effect of color stability, flexibility, shrinkage, hardness, and useful life. It may also presents no impact on the surrounding materials being sealed including but not limited to: fiberglass, glass, granite, marble, slate, vinyl, poly-vinyl chloride, porcelain, Corian™, paint, polyurethane, or wood materials.

As various modifications could be made to the exemplary embodiments, as described above without departing from the scope of the invention, it is intended that all matter contained in the foregoing description shall be interpreted as illustrative rather than limiting. Thus, the breadth and scope of the present invention should not be limited by any of the above-described exemplary embodiments, but should be defined only in accordance with the following claims appended hereto and their equivalents

What is claimed is:

1. A caulking bead release compound for creating a symmetric bead of caulk comprising:
a surfactant;
a co-solvent;
a polymer;
a carrier;
a coupling agent;
a defoamer to aid in the spraying application of the compound;
and a corrosion inhibitor to prevent discoloring.

2. The compound of claim 1, wherein the surfactant comprises a weight in the range 1 to 15% of the collective weight of the compound.

3. The compound of claim 1, wherein the co-solvent comprises from the group alcohols, ketones, glycols, esters, aliphatics, aromatics, amines, and glycols.

4. The compound of claim 1, wherein the polymer comprises a weight in the range 5.25% to 26% of the collective weight of the compound.

5. The compound of claim 1, wherein the polymer comprises acrylic functionality.

6. The compound of claim 1, wherein the polymer is comprised from the group consisting of styrene-butadiene rubber, poly-vinyl acetate, acrylic, ethylene-vinyl acetate, poly vinyl chloride, acrylonitrile-butadiene-styrene, styrene-butadiene rubber, butyl rubber, silicone, urethane, and polyurethane.

7. The compound of claim 1, wherein the surfactant comprises a minimum of 1% and a maximum of 15% by weight of the compound.

8. The compound of claim 1 wherein the surfactant comprises the group consisting of alky polysaccharides, alkylamine ethoxylates, amine oxides, block copolymers, caster oil ethoxylates, ceto-oleyl alcohol ethoxylates, ceto-stearyl alcohol ethoxylates, decyl alcohol ethoxylates, dinonyl phenol ethoxylates, dodecyl phenol ethoxylates, end-capped ethoxylates, alkyl dimethylamines, alkyl amidopropylamines, quaternised amine ethoxylates, quaternary ammonium compounds, diethanolamines, comb-graft copolymer, condensed naphthalene sulphonates, polycarboxylates, ethoxylated alkanolamides, ethylene glycol esters, fatty acid alkanolamides, fatty alcohol alkoxylates, lauryl alcohol ethoxylates, mono-branched alcohol ethoxylates, nonyl phenol ethoxylates, octyl phenol ethoxylates, random copolymer alkoxylates, sorbitan ester ethoxylates, stearic acid ethoxylates, synthetic alcohol ethoxylates, tall oil fatty acid ethoxylates, tallow amine ethoxylates, alkyl ether phosphates, alkyl phenol ether phosphates, alkyl phenol ether sulphates, alkyl naphthalene sulphonates, condensed naphthalene sulphonates, fatty alcohol sulphates, alkyl ether carboxylic acids and salts, alkyl ether sulphates, mono-alkyl sulphosuccinamates, di-alkyl sulphosuccinates, alkyl phosphates, alkyl benzene sulphonic acids and salts, alpha olefin sulphonates, alkyl ampho(di)acetates, amido betaines, alkyl betaines, fluorosurfactants, aromatic hydrocarbon sulphonic acids, salts and blends.

9. The composition of claim 1, wherein the coupling agent is selected from a group of chemicals consisting of glycols, glycol ethers or glycol ether esters.

10. The compound of claim 1, wherein the carrier comprises a weight in the range 5% to 90% of the collective weight of the compound.

11. The compound of claim 10, wherein the carrier comprises water.

12. The compound of claim 1, wherein the water comprises between 5% and 90% by weight of the compound.

13. The compound of claim 1, wherein the defoamer comprises a weight in the range 0.1% to 5% of the collective weight of the compound.

14. The compound of claim 1, further comprising an aerosol propellant and lubricant combined with the compound in order to make the compound sprayable.

15. The compound of claim 1, wherein the propellant comprises between 2% and 45% by weight of the net contents of the compound.

16. The compound of claim 1, wherein the coupling agent comprises between 1% and 25% by weight of the compound.

17. The compound of claim 1, wherein the corrosion inhibitor comprises between 0.1% and 0.75% by weight of the compound.

18. The compound of claim 1, wherein the corrosion inhibitor comprises from a group consisting of alkanolamine borate, ammonium benzoate, azoles, amines, nitrites, phosphates, molybdates, phosphonates, silicates or chromates.

19. A method of smoothing a caulk bead by applying a compound comprising the following elements to a bead of caulk:
a surfactant;
a co-solvent;
a polymer;
a carrier;
a coupling agent;
a defoamer to aid in the spraying application of the compound;
and a corrosion inhibitor to prevent discoloring.

20. The method of claim 9 wherein, the compound is sprayed onto the caulk bead from a container wherein the compound has been mixed with an aerosol propellant and a lubricant.
